(19) United States
(12) Patent Application Publication
(10) Pub. No.: US 2023/0245186 A1
(43) Pub. Date: Aug. 3, 2023

(54) SYSTEMS AND METHODS FOR OFFER LISTINGS

(71) Applicant: Walmart Apollo, LLC, Bentonville, AR (US)

(72) Inventors: Shrenik Rajendra Shah, Belmont, CA (US); Aayush Agrawal, Berkeley, CA (US); Olivia Jean Doss, Bentonville, AR (US); Deron Johnson Gardner, Bentonville, AR (US); Shalini Mandara Ramachandra, Bangalore (IN); Renjith Lal Erreseril, Bentonville, AR (US)

(73) Assignee: Walmart Apollo, LLC, Bentonville, AR (US)

(21) Appl. No.: 17/589,784

(22) Filed: Jan. 31, 2022

(51) Int. Cl. G06Q 30/02; G06Q 30/06

(52) U.S. Cl. CPC G06Q 30/0283; G06Q 30/0639; G06Q 30/0611

(57) ABSTRACT

A system comprising one or more processors and one or more non-transitory computer-readable media storing computing instructions that, when executed on the one or more processors, cause the one or more processors to perform: generating, using one or more store signals, a lifecycle metric for each respective item sold in a respective storefront of multiple storefronts, wherein the multiple storefronts are located in one or more geographic locations, and wherein each respective item is concurrently listed online via a website; determining offer listing data for the respective item; generating an offer listing metric by reconciling, using a reconciliation algorithm, the offer listing data for the respective item with an offer store data; and transmitting the offer listing metric to user interfaces, wherein the offer listing metric indicates that the respective item is available for sale at the respective storefront. Other embodiments are disclosed.

### TECHNICAL FIELD

This disclosure relates generally relates to for offer listings.

### BACKGROUND

Browsing an item online listed as for sale at an in-store geographic location can include listing an incorrect quantity of that item at the in-store geographic location at a given time due to the same item being sold at multiple in-store geographic locations at the given time.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for generating offer listings, according to an embodiment;

FIG. 4 illustrates an exemplary webpage display of an offer listing, according to an embodiment;

FIG. 5 illustrates an exemplary a flow diagram for a generating an exemplary offer listing, according to an embodiment;

FIG. 6 illustrates a flow chart for a method, according to an embodiment; and

FIG. 7 illustrates a flow chart for a method, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 1 second, 10 seconds, 15 seconds, or another suitable time delay period.

### DESCRIPTION OF EXAMPLES OF EMBODIMENTS

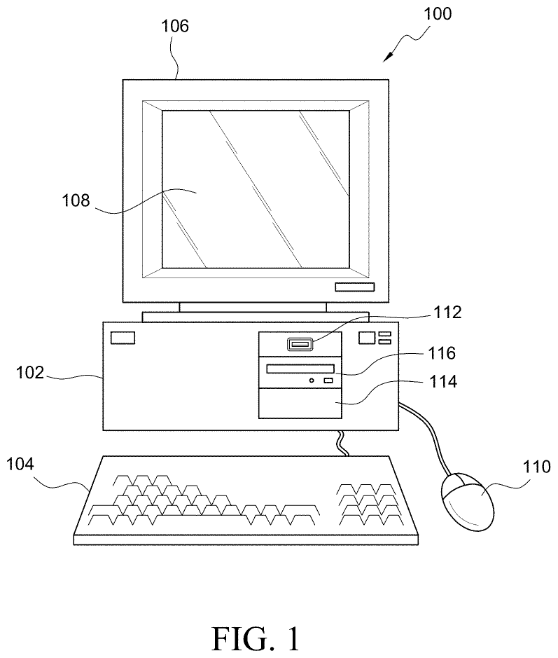

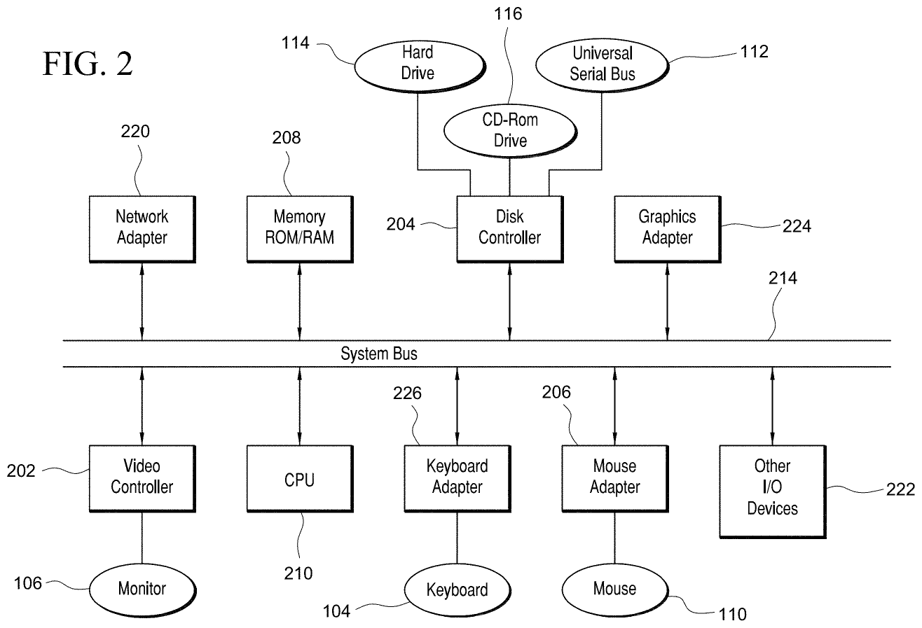

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

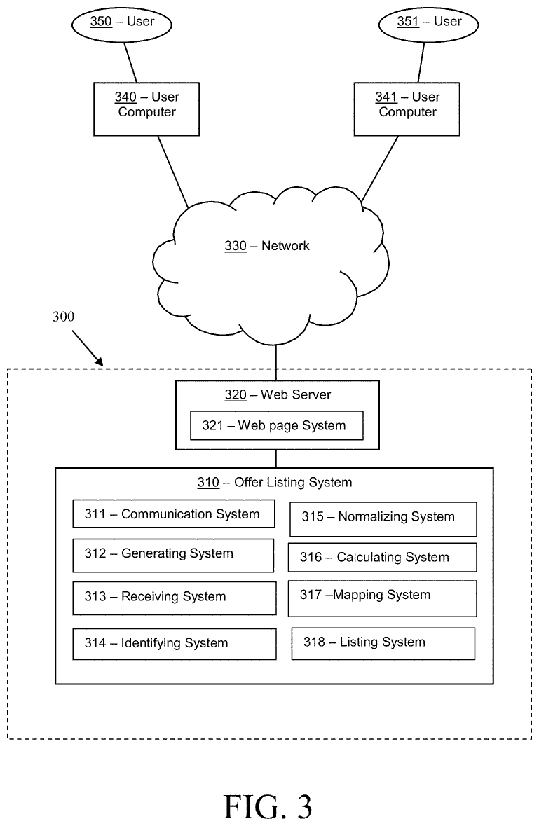

Turning ahead in the drawings, FIG. 3 illustrates a block diagram of a system 300 that can be employed for a generating an online offer listing for an item sold at multiple storefronts corresponding to a geographic location, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include an offer listing system 310 and/or a web server 320. Offer listing system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, offer listing system 310 and/or web server 320. Additional details regarding offer listing system 310 and/or web server 320 are described herein.

In a number of embodiments, each of offer listing system 310 and/or web server 320 can be a special-purpose computer programed specifically to perform specific functions not associated with a general-purpose computer, as described in greater detail below.

In some embodiments, offer listing system 310 and/or web server 320 can be in data communication through network 330 with one or more user computers, such as user computers 340 and/or 341. Network 330 can be a public network (such as the Internet), a private network or a hybrid network. In some embodiments, user computers 340-341 can be used by users, such as users 350 and 351, which also can be referred to as vendors, employees, associates, or customers, in which case, user computers 340 and 341 can be referred to as associate computers. In many embodiments, web server 320 can host one or more sites (e.g., websites) that allow users to browse and/or search for offer listings sold at multiple storefront locations from vendors or sellers, in addition to other suitable activities.

In some embodiments, an internal network that is not open to the public can be used for communications between offer listing system 310 and/or web server 320 within system 300. Accordingly, in some embodiments, offer listing system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can include the Virtual Retinal Display™ product, or similar product by the University of Washington of Seattle, Wash., United States of America. Meanwhile, in further specific examples, a limb mountable wearable user computer device can include the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In several embodiments, offer listing system 310 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to offer listing system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of offer listing system 310. In a similar manner, the processors and/or the non-transitory computer-readable media can be local and/or remote to each other.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between offer listing system 310, web server 320, a web page system 321, and/or the one or more databases can be implemented using any suitable manner of wired and/or wireless communication. Accordingly, offer listing system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, offer listing system 310 can include a communication system 311, a generating system 312, a receiving system 313, an identifying system 314, a normalizing system 315, a calculating system 316, a mapping system 317, and/or a listing system 318. In several embodiments, web server 320 can include web page system 321. In many embodiments, the systems of offer listing system 310 can be modules of computing instructions (e.g., software modules) stored at non-transitory computer readable media that operate on one or more processors. In other embodiments, the systems of offer listing system 310 can be implemented in hardware.

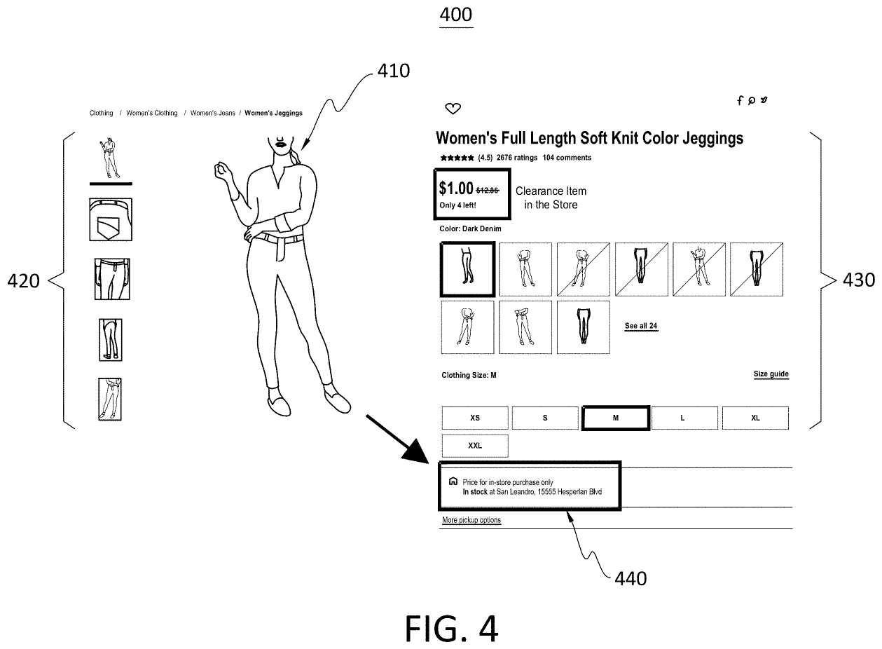

Referring to the drawings, FIG. 4 illustrates an exemplary webpage display of a user interface 400, according to an embodiment. In several embodiments, user interface 400 can include an image 410, a set of images 420, a display of images 430, and an image box 440. Image 410 can be an image of the item available for sale at a storefront, and set of images 420 can be thumbnail images of different views of the item, which a user can select to change the actual image shown for image 410. Additionally, display of images 430 can be different options for the item available for sale at the storefront. The different options can include different sizes, different colors, different quantities, etc., and image box 440 can include text confirming, among other things, that the item (and its options) are available for sale at the storefront. In many embodiments, user interface 400 is merely exemplary and is not limited to the embodiments presented herein. User interface 400 can be employed in many different embodiments or examples not specifically depicted or described herein. In some embodiments, user interface 400 can refer to any display screen of a desktop computer, an electronic mobile device, and/or another suitable electronic device.

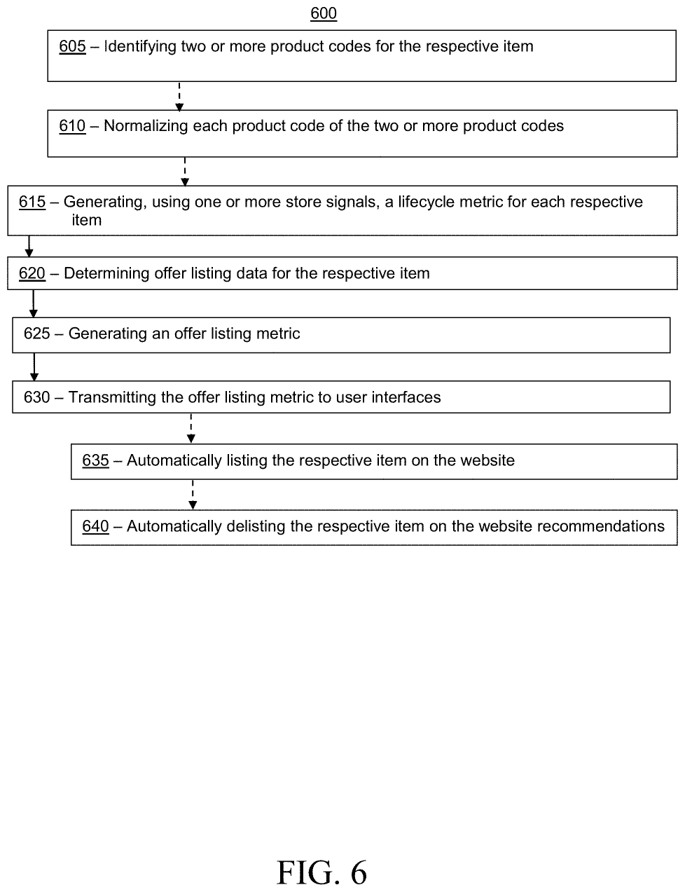

In several embodiments, an exemplary webpage can display each of the images on a display screen in any suitable order, such as images 410, 420, 430, and 440. In some embodiments, an item and a price can be listed or posted on an exemplary webpage as an in-store purchase rather than an online purchase, where the in-store purchase can be specific to one or more geographic locations of one or more storefronts, as illustrated in image box 440. In various embodiments, a price and a quantity of items can also be listed on the webpage, as illustrated in display of images 430. In several embodiments, FIG. 4 can be implemented as described below in connection with block 630 (FIG. 6).

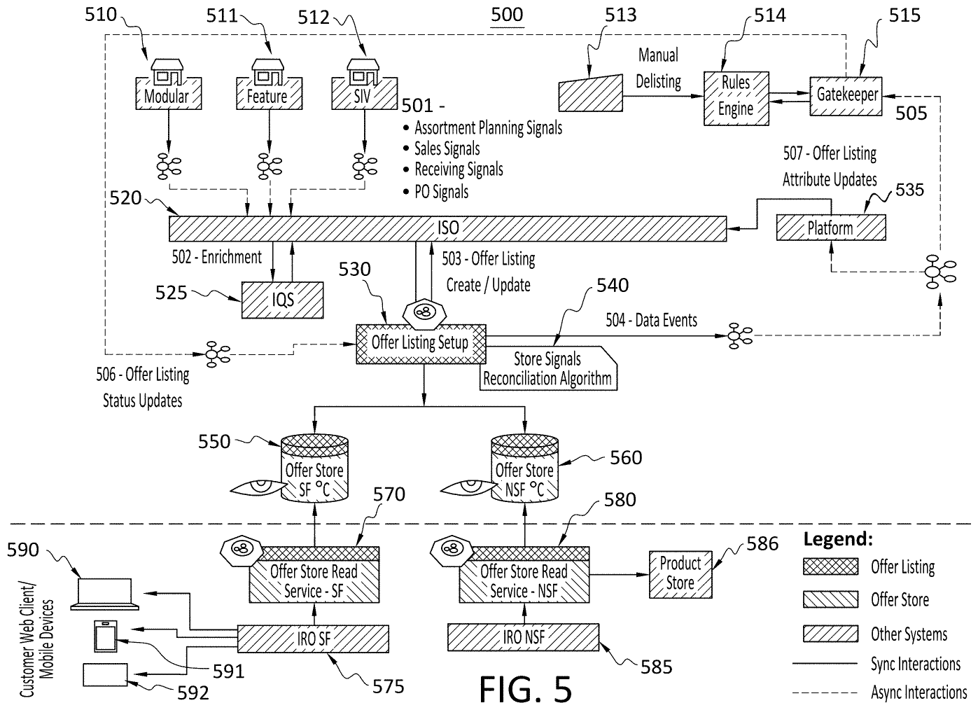

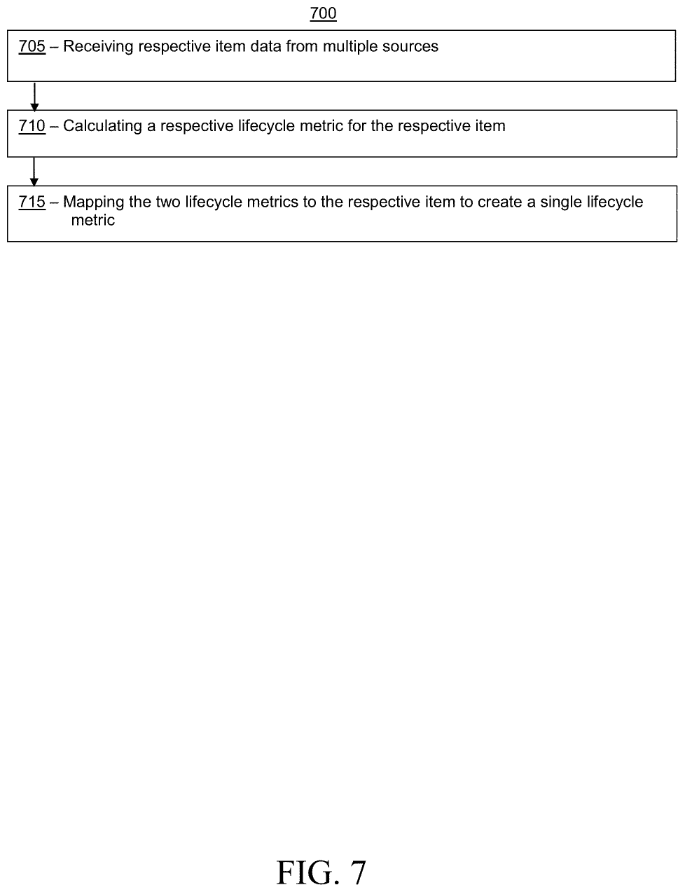

Turning ahead in the drawings, FIG. 5 illustrates an exemplary a flow diagram for a method 500 of a generating an offer listing, according to an embodiment. Method 500 can be similar to method 600 (FIG. 6, described below) and method 700 (FIG. 7, described below). Method 500 can be employed in many different embodiments and/or examples not specifically depicted or described herein. In some embodiments, the procedures, the processes, and/or the activities of method 500 can be performed in the order presented or in parallel. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as offer listing system 310 and/or web server 320. The processor(s) can be similar or identical to the processor(s) described above with respect to computer system 100 (FIG. 1).

In several embodiments, method 500 can include an activity 501 of sending store data signals from multiple store system sources to an item set up orchestrator (ISO) 520. In some embodiments, store data signals can include modular signals (modulars) 510, feature signals (features) 520, and store item validity (SIV) signals 530. In many embodiments, method 500 can proceed after activity 501 to an activity 502. In several embodiments, activity 501 can be implemented as described below in connection with blocks 605, 615 and 625 (FIG. 6) and 705, 710, 715 (FIG. 7).

In various embodiments, method 500 can include activity 502 of enriching the data of the store data signals with additional information using an item query service (IQS) 525. In some embodiments, enriching the data can begin by ISO 520 sending the store data signals to IQS 525. In several embodiments, the additional information can include additional data used by the reconciliation algorithm, online product data, sales data, purchase order details, and/or another suitable type of data. In many embodiments, IQS 525 can send the additional information back to ISO 520 where ISO 520 enriches the store data signals. In many embodiments, method 500 can proceed after activity 502 to an activity 503. In several embodiments, activity 502 can be implemented as described below in connection with block 615 (FIG. 6) and block 705 (FIG. 7).

In various embodiments, method 500 can include activity 503 of creating or modifying an offer listing metric, by using a reconciliation algorithm 540, with offer listing set up 530. In several embodiments, ISO 520 can continuously listen to signals from the input systems, modular signals (modulars) 510, feature signals (features) 520, and store item validity (SIV) signals 530, and enrich the messages with additional elements that can represent the item (e.g., product) such as, offerID, GTINs, and/or another suitable elements, in real-time. In various embodiments, ISO 520 can send calls to offer listing setup 530 to process the additional input of signals and additional elements. In several embodiments, based on the input and the source data, the offer listing set up 530 internally computes, based on the rules, to determine if an offer listing metric can be created and/or updated. In various embodiments, offer listing metrics created and/or updated can send out messages downstream to consuming systems, such as gatekeeper 515.

In some embodiments, offer listing set up 530 can receive enriched store data signals from multiple store system sources from (ISO) 520 that can be used as input for the reconciliation algorithm 540. In several embodiments, once an offer listing metric is created, offer listing set up 530 can send it to ISO 520. Similarly, in many embodiments, the reconciliation algorithm 540 also can update or modify an existing offer listing metric using offer listing setup 530 and send the updated or modified offer listing metric back to ISO 520. In many embodiments, method 500 can proceed after activity 503 to an activity 504. In several embodiments, activity 503 can be implemented, as described below, in connection with blocks 620 and 625 (FIG. 6),

In some embodiments, method 500 can include activity 504 of sending data events to multiple databases for one or more downstream systems stored in an attribute management platform 535. In several embodiments, data mutations of the offer listings can be published as data events, such as large scale data mutation events or auditing events. In various embodiments, such large scale data mutation events and/or auditing events can be consumed by interested downstream systems that are interested in the data events on the offer listing so that necessary actions can be taken further downstream in such systems. In some embodiments, activity 504 can include event-driven architecture adopted for integrations between the offer listing and the downstream systems. In several embodiments, the event-driven architecture also can be used to publish large scale mutations to the offer listing. In various embodiments, method 500 can proceed from activity 504 to an activity 505. In some embodiments, activity 504 can be implemented, as described below, in connection with blocks 705, 710, and 715 (FIG. 7).

In several embodiments, method 500 can include activity 505 of determining when to list or delist an offer listing metric on a website based on data output from a gatekeeper module 515. In various embodiments, gatekeeper module 515 can execute a set of rules on modified data to either list or delist an offer listing metric (e.g., an offer listing). In some embodiments, gatekeeper module 515 can utilize systems such as data records 513 and/or rules engine 514 to receive modified data or updated data for an offer listing. In a number of embodiments, method 500 can proceed after 505 to an activity 506. In many embodiments, activity 505 can be implemented, as described below, in connection with blocks 630, 635, 640 (FIG. 6).

In a number of embodiments, method 500 can include activity 506 of transmitting updates (e.g., status updates) or modifications to from gatekeeper 515 to offer listing setup 530. In several embodiments of this feedback loop, offer listing setup 530 acts upon messages transmitted by gatekeeper 515 to update, modify or change a lifecycle status of an offer listing for each item to either list or delist from a website. In many embodiments, method 500 can proceed after activity 506 to an activity 507. In several embodiments, activity 506 can be implemented, as described below, in connection with blocks 630, 635, 640 (FIG. 6).

In some embodiments, method 500 can include activity 507 of transmitting additional attribute changes per the rules defined for an attribute management platform 535. In several embodiments, all or some of the additional attribute changes to the offer listing can include data being written or published to either the offer store non-site facing (NSF) 560 or offer store site facing (SF) 550. In many embodiments, the data for each offer listing can be read by an item read orchestrator (IRO) for site facing 570 to render IRO site facing data 575 to one or more display screens of user interfaces of multiple electronic devices, where such electronic devices can include a desktop computer 590, a mobile electronic device 591, or an electronic device.

In several embodiments, data for each offer listing can be read by an IRO for non-site facing 580 to render IRO non-site facing data 585. In various embodiments, non-site facing 580 can transmit data to product store 586. In some embodiments, IRO site facing data 575 can cater (e.g., focus) or address the data used for a respective user interface display. In various embodiments, IRO non-site facing 585 can cater or address all of the ingestions, mutations, publishing, internal application queries and reads, supplementary data as input for the reconciliation algorithm. In various embodiments, activity 507 can be implemented, as described below, in connection with blocks 630 and 635 (FIG. 6).

Turning ahead in the drawings, FIG. 6 illustrates a flow chart for a method 600, according to another embodiment. In some embodiments, method 600 can be a method of automatically generating an offer listing of a quantity of an item listed online and sold at a storefront location. In many embodiments, generating an offer listing metric can be based on using a reconciliation algorithm. Method 600 is merely exemplary and is not limited to the embodiments presented herein. Method 600 can be employed in many different embodiments and/or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped. In several embodiments, system 300 (FIG. 3) can be suitable to perform method 600 and/or one or more of the activities of method 600.

In these or other embodiments, one or more of the activities of method 600 can be implemented as one or more computing instructions configured to run at one or more processors and configured to be stored at one or more non-transitory computer-readable media. Such non-transitory computer-readable media can be part of a computer system such as offer listing system 310 and/or web server 320. The processor(s) can be similar or identical to the processor(s) described above with respect to computer system 100 (FIG. 1).

Referring to FIG. 6, method 600 can optionally and additionally include a block 605 of identifying two or more product codes for the respective item sold in the multiple storefronts, wherein each storefront of the multiple storefronts uses a different naming convention for a product code of the two or more product codes for the respective item, and wherein each product code of the two or more product codes for the respective item is specific to a respective storefront of the multiple storefronts. In many embodiments, block 605 can be implemented as described above in connection with FIG. 5.

In several embodiments, method 600 can optionally and additionally include a block 610 of normalizing each product code of the two or more product codes for the respective item into a single global trade item number (GTIN) for the respective item. In some embodiments, GTIN can be used as an item identifier in the data model, as GTIN is globally used across the industry.

In various embodiments, method 600 can include a block 615 of generating, using one or more store signals, a lifecycle metric for each respective item sold in a respective storefront of multiple storefronts, wherein the multiple storefronts are located in one or more geographic locations, and wherein each respective item is concurrently listed online via a website. In many embodiments, block 615 can be implemented as described above in connection with FIG. 5.

In several embodiments, one or more store signals can include a receiving signal that indicates when a storefront receives a global trade item number (GTIN) for the respective item to be sold at the storefront within a predetermined period of time. In some embodiments, one or more store signals also can include a recall signal that indicates when a particular GTIN for the respective item is recalled from the storefront. In various embodiments, one or more store signals further can include a sales signal that indicates when the GTIN for the respective item in the storefront has been sold during a historical period of time. In several embodiments, one or more store signals additionally can include an assortment planning signal that indicates when a modification for the respective item has occurred within the predetermined period of time.

In various embodiments, method 600 further can include a block 620 of determining offer listing data for the respective item based on at least (i) first data of the lifecycle metric for the respective item and (ii) second data received from an item setup orchestrator data model. In some embodiments, an offer listing metric or offer listing can be a source of truth of a respective quantity of items carried at a storefront location while a user browses a webpage or website. In some embodiments, first data can include items, modulars 510, features 520, and store SIV signals 530, such data can be similar or identical to data in blocks 510, 511, and/or 512 (FIG. 5). In various embodiments, input from modulars 510, and/or features 520, indicates the dates that the item (e.g., product) can be on the shelf in one or more storefronts, while the SIV signals indicate a quantity of items sold in each storefront. In some embodiments, item setup orchestrator data model can be similar or identical to block 520 (FIG. 5, as described above. In several embodiments, offer listing data or metrics can include a true representation of a quantity of items sold or carried by a storefront location in real time. In many embodiments, block 620 can be implemented as described above in connection with FIG. 5.

In some embodiments, ISO 520 can allow data to be orchestrated to different resource tiers to process. In various embodiments, each of the teams for modular 510, features 520 and SIV 530, can publish messages to ISO, where ISO continuously listens for new signals to process. In several embodiments, upon receiving the messages (e.g., data messages), ISO 520 can leverage IQS 525 (Item Query Services) to pull in additional offer level data from a catalog, based on the GTIN input, to form the input data structure fed or sent to ISO 520, where the input data can be used by other offer listing systems, to process and create and/or update offer listings (e.g., offer listing metrics). In several embodiments, data contracts agreed between the various systems and the ISO systems can use mappers to convert the data between the various system contracts, various systems can include modular 210, features 511, SIV 512, ISO 520, IQS 525, offer listing set up 530, reconciliation algorithm 540, attribute management platform 535, and/or another suitable system,

In some embodiments, block 620 can include the second data received from the item setup orchestrator data model comprising product data for the respective item that is viewed online. In several embodiments, product data can include GTINs that are attached to the product (e.g., item), a product category, a subcategory, a brand and/or another suitable type of product data. In various embodiments, second data can include enrichment data such as item price type codes, product hierarchy, and/or another suitable type of enrichment data, such data can be similar to identical to data in blocks 515, 525 and/or 530 (FIG. 5).

In several embodiments, method 600 can include a block 625 of generating an offer listing metric by reconciling, using a reconciliation algorithm, the offer listing data for the respective item with an offer store data for the respective item. In various embodiments, a product (e.g., item) can be linked to multiple GTINs and can be placed in multiple locations within a store. In some embodiments, a storefront can hold data across all of the GTINs and reconcile data across all of those GTIN to create the one offer listing metric for that storefront (e.g., geographical locations of stores). In many embodiments, block 625 can be implemented as described above in connection with FIG. 5.

In some embodiments, the reconciliation algorithm can support multiple sources. In some embodiments, a reconciliation algorithm 1 can be expressed as follows:

[symbol] (1)

First compute a start date and an end date for each of the sources at the GTIN-Store-Source level depending on the store signals and the attributes the signals carry.

Modulars send start dates for items that are planned to be in the store all the time, such as, top selling items, non-seasonal items, and another suitable item sold at a storefront. Compute an end date using a smart computation. In many embodiments, smart computation can include a method of computation as follows:
Modulars can be setup with and/or without an end date.
The same item also can be setup on multiple modulars with different end dates.
The system analyzes the different end dates to compute the longest end date to set.
In cases without an end date provided, the system sets up a new system to assign the end date that can already be configured.

Features dates are dependent so past sales performance (e.g., indicative), thus, so it needs additional Sales flag to compute actual start dates and end dates for features with an additional sales flag.

SIV data has no date, thus use a smart computation of a start date and an end date by using other store signals.

Start and End Dates for seasonal items may need to recomputed depending on store signals

The store source systems can send updates (e.g., modifications, status) to extend particular end dates or advance the end dates. At this point, the start dates and end dates are recomputed across Modulars and/or Features.

Certain start dates and/or end dates are computed when there is a presence of certain store signals, such as SIV data, sales signals, purchase order signals, and/or another suitable signal.

After computation of start dates and end dates are completed for each store system source, aggregate the dates across the 3 store system sources to arrive at an overall start date and end date for a GTIN-Store.

Dates across Modulars and Features can be overlapping

Dates across Modulars and Features can be disconnected and/or differ by a few months apart from one another.

There is no guarantee in receiving the order of data arrival from different store system sources, the algorithm takes the data available at that point in time and computes the dates accordingly. Later when data changes, as the algorithm learns of newer data, then the algorithm can perform the date computation differently.

Store data signals from one store system source can impact all or some of the dates of other store system sources.

Each time a store signal is received, a computation of start dates and end dates across store system sources can be initiated.

Aggregate the dates across all GTINs for the offer listing for an item (e.g., a product) to arrive at an overall start date and end date at the offer listing level.
While the algorithm is aggregating dates, it can also aggregate several different attributes, such as a recalled indicator, a sales Indicator, a purchase order indicator, and/or another suitable indicator, at the offer listing level. A recalled indicator can send recall data for an item, a sales indicator can send a history of sales data for an item, a purchase order indicator can send purchase order data or historical data for an item.
The algorithm follows exclusion rules to avoid ingesting data that is not useful for offer listings and/or offer listing metrics, such exclusion rules can include:

Exclude data that not a part of assortment planning wherein there is not data or sales data in the last 14 days, and/or no data for purchase orders.

Exclude data for clearance items.

Exclude data for recalled GTINs for items, if data previously used in aggregation, where the data can be reconciled without GTINs.

Once the data can be aggregated and reconciled, the date can be the basis for the rules that determine whether to list or delist the offer listing on an online website or webpage.

In some embodiments, data can be collected from 3 different sources, (1) Modulars (2) Features and/or (3) SIV (Store item validity). In many embodiments, modular can include an assortment planning system (e.g., planograms) that discloses the products that are supposed to be in a respective “shelf” in a respective geographical storefront. In several embodiments, features can include assortment marketing system that tells us what products are being marketed where in the store, and SIV (Store Item Validity)—tells us what items are being replenished for the stores.

In various embodiments, using the reconciliation algorithm can include collecting item data from multiple sources. In several embodiments, using the reconciliation algorithm also can include deriving, from the item data, a start date and an end date for the respective item based on a global trade item number (GTIN) assigned to the respective item. In some embodiments, using the reconciliation algorithm further can include aggregating the offer listing data for each GTIN for the respective item.

In a number of embodiments, store system signals (e.g., store signals) can include:

a. Receiving=Signal to indicate that Goods Received Note (GRN) exists for the GTIN in the store in the last 90 days
b. Recalled=Signal to indicate that the specific GTIN has been recalled from the store
c. Sales Signal=Signal to indicate that Sales exists for the GTIN in the store in last 14 days
d. Assortment Planning Signals=Create/Modify/Delete changes in the Modulars and Features planning systems for the items

In several embodiments, item identifiers can be utilized by the different store system sources, such as:

a. Modulars and Features can use universal product (UPC) codes
b. SIVs can use GTINs
c. A store catalog data model can use identification codes

In some embodiments, aggregating all of the data can include cleansing and harmonizing the data such that data fits into a final offer listing data model. In several embodiments, cleansing and harmonizing the data can include:

a. All messages with UPC identifiers can be first converted to GTIN as the single item identifier.
b. The GTIN can be used to lookup the items in a catalog data model to locate (e.g., find) an associated offer identification (ID).
c. Every OfferID (e.g., an item or product) can be comprised of several different GTINs each supplied by different suppliers or vendors. Display one product or item on a website. For example: Fresh Produce—Bananas sold on a website can be a single product for the user (e.g., customer). In this example, bananas can be sourced from multiple suppliers geographically across the country, where each supplier can be assigned their own GTIN for the same product. In following with this example, Bananas can be assigned a single OfferID, but have several different GTINs associated with that product. When the data received in from store systems (e.g., store system sources) at a GTIN level, aggregate the GTINs to the offer level to unify the online and storefront concepts. Upon aggregating the information or data, store the data at a GTIN-Store level for each store system source.

In various embodiments, the reconciliation algorithm can run on granular data for the different store system sources. In several embodiments, some of the rules in the algorithm can be exclusive to some store system sources, while other rules can be used in combination of the multiple store system sources of data. In some embodiments, there can be no specific order in which the source systems send the data (e.g., asynchronous event based architecture), thus the algorithm adapts to the data available at a point in time and executes its logic and rules accordingly to determine if the offer listing data is valid and/or eligible for listing online for one or more storefronts at respective geographical locations.

In a number of embodiments, after the offer listing data is reconciled, generating the offer listing metric can include segregating the offer listing metric into two or more clusters. In several embodiments, the at least two clusters can include (i) a site-facing cluster and (ii) a non-site facing cluster,

In various embodiments, generating the offer listing metric can include writing a command to transmit one of the at least two clusters to the user interfaces of the multiple electronic devices.

In several embodiments, transmitting the offer listing metric can include executing the command.

In various embodiments, method 600 also can include a block 630 of transmitting the offer listing metric to user interfaces of multiple electronic devices that requested information regarding the respective item, wherein the offer listing metric indicates that the respective item is available for sale at the respective storefront when the respective item is available for sale at two or more of the multiple storefronts. In many embodiments, block 630 can be implemented as described above in connection with FIG. 4 and FIG. 5.

In a number of embodiments, transmitting the offer listing metric can include reading the offer listing metric using an item read orchestrator to render the offer listing metric to an online website where a user can view the offer listing metric in real-time.

In a number of embodiments, method 600 additionally can include a block 635 of automatically listing the respective item on the website for a period of time (e.g., displaying the respective item or causing the respective item to be displayed on the website on a GUI of a display screen) when the respective item is sold at a respective storefront of the multiple storefronts, wherein each listing comprises a respective geographic location, and wherein each listing is listed on the website beginning at a start date. In many embodiments, block 635 can be implemented as described above in connection with FIG. 4 and FIG. 5.

In various embodiments, method 600 further can include a block 640 of automatically delisting the respective item on the web site after an end date of the lifecycle metric of the respective item expires. In many embodiments, block 640 can be implemented as described above in connection with FIG. 4 and FIG. 5.

Turning ahead in the drawings, FIG. 7 illustrates a flow chart for a method 700, according to another embodiment. In some embodiments, method 700 can be a method of automatically calculating a respective lifecycle metric of an item carried at one or more storefronts for a time range (e.g., a period of time). In many embodiments, method 700 also can be a method of mapping two lifecycle metrics to create a single lifecycle metric for an item carried or sold at a same storefront. Method 700 is merely exemplary and is not limited to the embodiments presented herein. Method 700 can be employed in many different embodiments and/or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped. In several embodiments, system 300 (FIG. 3) can be suitable to perform method 700 and/or one or more of the activities of method 700.

In these or other embodiments, one or more of the activities of method 700 can be implemented as one or more computing instructions configured to run at one or more processors and configured to be stored at one or more non-transitory computer-readable media. Such non-transitory computer-readable media can be part of a computer system such as offer listing system 310 and/or web server 320. The processor(s) can be similar or identical to the processor(s) described above with respect to computer system 100 (FIG. 1).

Referring to FIG. 7, method 700 can include a block 705 of receiving respective item data from multiple sources for the respective item sold in a respective storefront of the multiple storefronts. In several embodiments, the respective item data can include respective digital signals mapped to each storefront of the multiple storefronts.

In some embodiments, block 705 can include receiving respective item data from the multiple sources including at least one of (i) a modular metric for the respective item, (ii) a feature metric for the respective item, and (iii) a store item validity metric for the respective item. In several embodiments, each source of the multiple sources can include respective item identifiers from one or more vendors.

In various embodiments, based on the respective digital signals, method 700 also can include a block 710 of calculating a respective lifecycle metric for the respective item based on a range of time when the respective item is carried in each storefront of the multiple storefronts. In some embodiments, each range of time for the respective item in a respective geographic location can include a respective start date and a respective end date.

In several embodiments, when more than one respective digital signal of the respective digital signals for the respective item is detected from a same storefront of the multiple storefronts, method 700 further can include a block 715 of mapping the two lifecycle metrics to the respective item to create a single lifecycle metric for the respective item sold in the same storefront. In some embodiments, where the respective item can be mapped to two lifecycle metrics, block 715 can include mapping the two lifecycle metrics to the respective item to create a single lifecycle metric for the respective item sold in the same storefront.

Returning to the drawings, in a number of embodiments, communication system 311 can at least partially perform activity 501 (FIG. 5) of sending store data signals from multiple store system sources to an item set up orchestrator, activity 504 (FIG. 5) of sending data events to multiple data bases for one or more downstream systems stored in an attribute management platform 535, activity 506 (FIG. 5) of transmitting updates (e.g., status updates) or modifications to from gatekeeper 515 to offer listing setup 530, activity 507 (FIG. 5) of transmitting additional attribute changes per the rules defined for an attribute management platform 535, block 630 (FIG. 6) of transmitting the offer listing metric to user interfaces of multiple electronic devices that requested information regarding the respective item, and/or block 705 (FIG. 7) of receiving respective item data from multiple sources for the respective item sold in a respective storefront of the multiple storefront.

In various embodiments, generating system 312 can at least partially perform activity 503 (FIG. 5) of creating or modifying an offer listing metric, by using a reconciliation algorithm 540 (FIG. 5), with offer listing set up 530 (FIG. 5), block 615 (FIG. 6) of generating, using one or more store signals, a lifecycle metric for each respective item sold in a respective storefront of multiple storefronts, and/or block 620 (FIG. 6) of determining offer listing data for the respective item based on at least (i) first data of the lifecycle metric for the respective item and (ii) second data received from an item setup orchestrator data model.

In several embodiments, receiving system 313 can at least partially perform activity 502 (FIG. 5) of enriching the data of the store data signals with additional information using an item query service (IQS) 525.

In some embodiments, identifying system 314 can at least partially perform block 605 (FIG. 6) of identifying two or more product codes for the respective item sold in the multiple storefronts. Different product codes for the same item can indicate that the item is sold (a) from the same vendor in different physical stores, (b) from different vendors at different physical stores, (c) from different vendors at the same physical store, (d) a combination or any of the above. Thus, a storefront can represent any of these scenarios.

In various embodiments, normalizing system 315 can at least partially perform block 610 (FIG. 6) of normalizing each product code of the two or more product codes for the respective item into a single global trade item number (GTIN) for the respective item.

In many embodiments, calculating system 316 can at least partially perform activity 505 (FIG. 5) of determining when to list or delist an offer listing metric on a web site based on data output from a gatekeeper module 515 (FIG. 5), block 625 (FIG. 6) of identifying two or more product codes for the respective item sold in the multiple storefronts, and/or block 710 (FIG. 7) of calculating a respective lifecycle metric for the respective item based on a range of time when the respective item is carried in each storefront of the multiple storefronts.

In some embodiments, mapping system 317 can at least partially perform block 715 (FIG. 7) of mapping the two lifecycle metrics to the respective item to create a single lifecycle metric for the respective item sold in the same storefront.

In several embodiments, listing system 318 can at least partially perform block 635 (FIG. 6) of automatically listing the respective item on the website for a period of time when the respective item is sold at a respective storefront of the multiple storefronts, and/or block 640 (FIG. 6) of automatically delisting the respective item on the website after an end date of the lifecycle metric of the respective item expires.

In several embodiments, web server 320 can include a webpage system 321. Webpage system 321 can at least partially perform sending instructions to user computers (e.g., 340-341 (FIG. 3)) based on information received from communication system 311.

In a number of embodiments, dividing the data for the IRO site facing data 575 and IRO non-site facing data 585 can be advantageous by isolating the separate workloads, thereby being able to scale the read and write workloads independently. In some embodiments, read and write workloads can address approximately 50 Million ingestions per day and about 50 Million attribute changes and/or publishing changes per day.

In some embodiments, the offer listing system can provide an improvement over a prior methods of using a single catalog model for online commerce and in-store (e.g., storefront) commerce that lacked the level of granularity to have the data at storefront level. In many embodiments, the prior method did not have a way to distinguish customer offer data by vendor and/or storefront. In such a case, the prior method lacked a way to validate (i) the accuracy of whether a quantity of each item displayed online as sold at a specific storefront existed and (ii) the eligibility of displaying an item via a website based on geo-location of a storefront. In various embodiments, advantages of generating offer listing metrics online as sold in a respective storefront location from one or more vendors can include creating a true picture of which items can be found at a store when a user browses a website.

In several embodiments, an event-driven architecture can include several advantages such as the following:

i. Ability to integrate different types of legacy systems
ii. Ability to integrate any new sources of data in the future, without changing the core design and data model
iii. Ability to do asynchronous publish-subscribe model
iv. Ability to process the store signals near real-time.
v. Ability stream approximately 50 million of messages or store system signals per day with ease.

In many embodiments, the techniques described herein can be used continuously at a scale that cannot be handled using manual techniques. For example, the number of daily and/or monthly ingestions per day, attribute changes and/or publishing changes per day, can exceed 50 million per day and/or other suitable numbers, and/or the number of products and/or items advertised on the website as sold in a storefront can exceed approximately ten million (10,000,000) approximately each day.

Various embodiments can include a system including one or more processors and one or more non-transitory computer-readable media storing computing instructions that, when executing on the one or more processors, cause the one or more processors to perform certain acts. The acts can include generating, using one or more store signals, a lifecycle metric for each respective item sold in a respective storefront of multiple storefronts. The multiple storefronts can be located in one or more geographic locations. Each respective item can be concurrently listed online via a website. The acts also can include determining offer listing data for the respective item based on at least (i) first data of the lifecycle metric for the respective item and (ii) second data received from an item setup orchestrator data model. The act further can include generating an offer listing metric by reconciling, using a reconciliation algorithm, the offer listing data for the respective item with an offer store data for the respective item. The acts additionally can include transmitting the offer listing metric to user interfaces of multiple electronic devices that requested information regarding the respective item. The offer listing metric can indicate that the respective item is available for sale at the respective storefront when the respective item is available for sale at two or more of the multiple storefronts.

A number of embodiments can include a method being implemented via execution of computing instructions configured to run at one or more processors and stored at one or more non-transitory computer-readable media. The method can include generating, using one or more store signals, a lifecycle metric for each respective item sold in a respective storefront of multiple storefronts. The multiple storefronts can be located in one or more geographic locations. Each respective item can be concurrently listed online via a website. The method also can include determining offer listing data for the respective item based on at least (i) first data of the lifecycle metric for the respective item and (ii) second data received from an item setup orchestrator data model. The method further can include generating an offer listing metric by reconciling, using a reconciliation algorithm, the offer listing data for the respective item with an offer store data for the respective item. The method additionally can include transmitting the offer listing metric to user interfaces of multiple electronic devices that requested information regarding the respective item. The offer listing metric can indicate that the respective item is available for sale at the respective storefront when the respective item is available for sale at two or more of the multiple storefronts.

Although automatically generating an offer listing for a quantity of an item sold at a storefront while being viewed online has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 3-7 may include different procedures, processes, and/or activities and be performed by many different modules, in many different orders, and/or one or more of the procedures, processes, or activities of FIGS. 3-7 may include one or more of the procedures, processes, or activities of another different one of FIGS. 3-7. As another example, the systems within offer listing system 310, communication system 311, generating system 312, receiving system 313, identifying system 314, normalizing system 315, calculating system 316, mapping system 317, listing system 318, web server 320, and/or web page system 321, can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform functions comprising:
generating, using one or more store signals, a lifecycle metric for each respective item sold in a respective storefront of multiple storefronts, wherein the multiple storefronts are located in one or more geographic locations, and wherein each respective item is concurrently listed online via a website;
determining offer listing data for the respective item based on at least (i) first data of the lifecycle metric for the respective item and (ii) second data received from an item setup orchestrator data model;
generating an offer listing metric by reconciling, using a reconciliation algorithm, the offer listing data for the respective item with an offer store data for the respective item; and
transmitting the offer listing metric to user interfaces of multiple electronic devices that requested information regarding the respective item, wherein the offer listing metric indicates that the respective item is available for sale at the respective storefront when the respective item is available for sale at two or more of the multiple storefronts.

2. The system of claim 1, wherein the computing instructions, when executed on the one or more processors, further cause the one or more processors to perform additional functions comprising:
identifying two or more product codes for the respective item sold in the multiple storefronts, wherein each storefront of the multiple storefronts uses a different naming convention for a product code of the two or more product codes for the respective item, and wherein each product code of the two or more product codes for the respective item is specific to a respective storefront of the multiple storefronts; and
normalizing each product code of the two or more product codes for the respective item into a single global trade item number (GTIN) for the respective item.

3. The system of claim 1, the computing instructions, when executed on the one or more processors, further cause the one or more processors to perform additional functions comprising:
receiving respective item data from multiple sources for the respective item sold in a respective storefront of the multiple storefronts, wherein the respective item data comprises respective digital signals mapped to each storefront of the multiple storefronts;
based on the respective digital signals, calculating a respective lifecycle metric for the respective item based on a range of time when the respective item is carried in each storefront of the multiple storefronts, wherein each range of time for the respective item in a respective geographic location comprises a respective start date and a respective end date; and
when more than one respective digital signal of the respective digital signals for the respective item is detected from a same storefront of the multiple storefronts, wherein the respective item is mapped to two lifecycle metrics, mapping the two lifecycle metrics to the respective item to create a single lifecycle metric for the respective item sold in the same storefront.

4. The system of claim 3, wherein the multiple sources comprise at least one of a modular metric for the respective item, a feature metric for the respective item, and a store item validity metric for the respective item, and wherein each source of the multiple sources comprise respective item identifiers from one or more vendors.

5. The system of claim 1, the computing instructions, when executed on the one or more processors, further cause the one or more processors to perform additional functions comprising:
automatically listing the respective item on the website for a period of time when the respective item is sold at a respective storefront of the multiple storefronts, wherein each listing comprises a respective geographic location, and wherein each listing is listed on the website beginning at a start date; and
automatically delisting the respective item on the website after an end date of the lifecycle metric of the respective item expires.

6. The system of claim 1, wherein the one or more store signals comprise:
a receiving signal that indicates when a storefront receives a global trade item number (GTIN) for the respective item to be sold at the storefront within a predetermined period of time;
a recall signal that indicates when a particular GTIN for the respective item is recalled from the storefront;
a sales signal that indicates when the GTIN for the respective item in the storefront has been sold during a historical period of time; and
an assortment planning signal that indicates when a modification for the respective item has occurred within the predetermined period of time.

7. The system of claim 1, wherein the second data received from the item setup orchestrator data model comprises product data for the respective item that is viewed online.

8. The system of claim 1, wherein using the reconciliation algorithm comprises:
collecting item data from multiple sources;
deriving, from the item data, a start date and an end date for the respective item based on a global trade item number (GTIN) assigned to the respective item; and
aggregating the offer listing data for each GTIN for the respective item.

9. The system of claim 1, wherein:
generating the offer listing metric comprises:
after the offer listing data is reconciled, segregating the offer listing metric into two or more clusters, wherein at least two clusters of the two or more clusters are stored in an item read orchestrator, and wherein the at least two clusters comprise a site-facing cluster and a non-site facing cluster; and
writing a command to transmit one of the at least two clusters to the user interfaces of the multiple electronic devices; and
transmitting the offer listing metric comprises:
executing the command.

10. The system of claim 1, wherein transmitting the offer listing metric comprises:
reading the offer listing metric using an item read orchestrator to render the offer listing metric to an online website where a user can view the offer listing metric in real-time.

11. A method being implemented via execution of computing instructions configured to run on one or more processors and stored at one or more non-transitory computer-readable media, the method comprising:
generating, using one or more store signals, a lifecycle metric for each respective item sold in a respective storefront of multiple storefronts, wherein the multiple storefronts are located in one or more geographic locations, and wherein each respective item is concurrently listed online via a website;
determining offer listing data for the respective item based on at least (i) first data of the lifecycle metric for the respective item and (ii) second data received from an item setup orchestrator data model;
generating an offer listing metric by reconciling, using a reconciliation algorithm, the offer listing data for the respective item with an offer store data for the respective item; and
transmitting the offer listing metric to user interfaces of multiple electronic devices that requested information regarding the respective item, wherein the offer listing metric indicates that the respective item is available for sale at the respective storefront when the respective item is available for sale at two or more of the multiple storefronts.

12. The method of claim 11, further comprising:
identifying two or more product codes for the respective item sold in the multiple storefronts, wherein each storefront of the multiple storefronts uses a different naming convention for a product code of the two or more product codes for the respective item, and wherein each product code of the two or more product codes for the respective item is specific to a respective storefront of the multiple storefronts; and
normalizing each product code of the two or more product codes for the respective item into a single global trade item number (GTIN) for the respective item.

13. The method of claim 11, further comprising:
receiving respective item data from multiple sources for the respective item sold in a respective storefront of the multiple storefronts, wherein the respective item data comprises respective digital signals mapped to each storefront of the multiple storefronts;
based on the respective digital signals, calculating a respective lifecycle metric for the respective item based on a range of time when the respective item is carried in each storefront of the multiple storefronts, wherein each range of time for the respective item in a respective geographic location comprises a respective start date and a respective end date; and
when more than one respective digital signal of the respective digital signals for the respective item is detected from a same storefront of the multiple storefronts, wherein the respective item is mapped to two lifecycle metrics, mapping the two lifecycle metrics to the respective item to create a single lifecycle metric for the respective item sold in the same storefront.

14. The method of claim 13, wherein the multiple sources comprise at least one of a modular metric for the respective item, a feature metric for the respective item, and a store item validity metric for the respective item, and wherein each source of the multiple sources comprise respective item identifiers from one or more vendors.

15. The method of claim 11, further comprising:
automatically listing the respective item on the website for a period of time when the respective item is sold at a respective storefront of the multiple storefronts, wherein each listing comprises a respective geographic location, and wherein each listing is listed on the website beginning at a start date; and
automatically delisting the respective item on the website after an end date of the lifecycle metric of the respective item expires.

16. The method of claim 11, wherein the one or more store signals comprise:
a receiving signal that indicates when a storefront receives a global trade item number (GTIN) for the respective item to be sold at the storefront within a predetermined period of time;
a recall signal that indicates when a particular GTIN for the respective item is recalled from the storefront;
a sales signal that indicates when the GTIN for the respective item in the storefront has been sold during a historical period of time; and
an assortment planning signal that indicates when a modification for the respective item has occurred within the predetermined period of time.

17. The method of claim 11, wherein the second data received from the item setup orchestrator data model comprises product data for the respective item that is viewed online.

18. The method of claim 11, wherein using the reconciliation algorithm comprises:
collecting item data from multiple sources;
deriving, from the item data, a start date and an end date for the respective item based on a global trade item number (GTIN) assigned to the respective item; and
aggregating the offer listing data for each GTIN for the respective item.

19. The method of claim 11, wherein:
generating the offer listing metric comprises:
after the offer listing data is reconciled, segregating the offer listing metric into two or more clusters, wherein at least two clusters of the two or more clusters are stored in an item read orchestrator, and wherein the at least two clusters comprise a site-facing cluster and a non-site facing cluster; and
writing a command to transmit one of the at least two clusters to the user interfaces of the multiple electronic devices; and
transmitting the offer listing metric comprises:
executing the command.

20. The method of claim 11, wherein transmitting the offer listing metric comprises:
reading the offer listing metric using an item read orchestrator to render the offer listing metric to an online website where a user can view the offer listing metric in real-time.
